(19) United States
(12) Patent Application Publication
(10) Pub. No.: US 2026/0065672 A1
(43) Pub. Date: Mar. 5, 2026

(54) GAZE-AWARE HUMAN ACTIVITY DETECTION & ANTICIPATION

(71) Applicant: Honda Motor Co., Ltd., Tokyo (JP)

(72) Inventors: Chenyi KUANG, Troy, NY (US); Nakul Agarwal, San Francisco, CA (US)

(21) Appl. No.: 19/202,448

(22) Filed: May 8, 2025

Related U.S. Application Data
(60) Provisional application No. 63/689,508, filed on Aug. 30, 2024.

(51) Int. Cl. G06V 20/40; G06V 10/82; G06V 10/84

(52) U.S. Cl. CPC G06V 20/41; G06V 10/82; G06V 10/84; G06V 20/46

(57) ABSTRACT

The disclosure provides systems/methods of predicting future actions from a video. The disclosed systems and methods can use a video of human interactions with an object as input to predict future human actions. The disclosed systems and methods jointly detect the gaze of the human in the video and the action (or human-object interactions (HOI)) of the human in the video to predict a future gaze. The detected gaze and action, as well as the predicted future gaze, can be used to predict future actions (or HOIs) of the human in the video.

### CROSS-REFERENCE TO RELATED APPLICATIONS

This application claims priority to U.S. Provisional Patent Application Ser. No. 63/689,508, entitled “GENERALIZABLE AND JOINT FRAMEWORK FOR GAZE-AWARE HUMAN ACTIVITY DETECTION & ANTICIPATION”, filed on Aug. 30, 2024, the entirety of which is hereby incorporated by reference.

### INCORPORATION BY REFERENCE OF APPENDIX

Appendix A, which is attached to this application, is hereby incorporated by reference in its entirety.

### BACKGROUND

Understanding human behavior in real-world environments is a fundamental challenge in computer vision, with applications that span robotics, autonomous systems, augmented reality, and surveillance. Two critical components of this understanding are the ability to analyze actions (or human-object interactions (HOI)) and human gaze behavior. Although significant progress has been made in both domains problems as separate tasks, leading to fragmented solutions that fail to capture the intricate interplay between gaze behavior and object interactions. Even the few works that jointly address them focus solely on recognition or detection in the current frame, without considering applications of the future, resulting in a lack of a holistic understanding of human behavior. Moreover, these methods have limited perspective and applicability as they only focus on either first-person or third-person videos, but not both.

Many state-of-the-art models focus exclusively on detecting HOI in images and videos, while some extend it to tackling anticipation (prediction of future) task as well. These methods excel at identifying “what” actions are taking place (e.g., “holding a cup” or “opening a door”) but fail to leverage the rich information provided by human gaze cues, which can offer insight into “where” attention is directed before an interaction occurs. On the other hand, gaze estimation and anticipation methods mainly focus on predicting the point of visual attention from first- or third-person perspectives. While these approaches are effective at modeling attention dynamics, they often overlook the contextual information provided by human-object interactions, which can improve the accuracy of gaze prediction.

Some works do incorporate gaze for action understanding, but they either model gaze and actions separately, or only focus on first person videos when modeling jointly. Additionally, these models do not explore the relationship between gaze and action in the future, as they lack anticipation capability. None of the above models provide a comprehensive human behavior analysis as they lack in some or the other aspect.

### SUMMARY

The present system and method include a unified end-to-end trainable architecture that integrates recognition and anticipation of both HOI and gaze, allowing for joint optimization of these tasks for comprehensive human behavior understanding. The present system and method include a Gaze Conditioned Spatial Attention (GCSA) submodule that provides human-object interaction cues in the spatial domain and a Gaze Conditioned Temporal Prediction (GCTP) submodule which simultaneously models temporal correlations between future gaze patterns and future actions. The present system and method can operate seamlessly on both egocentric (first-person) and exocentric (third-person) video data, enabling broader applicability across diverse scenarios.

The simultaneous recognition and anticipation of both human-object interactions and human gaze behavior offer several advantages over traditional single-task approaches. Anticipating HOIs require understanding not only what actions are currently taking place but also what actions are likely to occur in the near future. For instance, if a person is looking at a cup on a table while reaching toward it, this combination of gaze fixation and hand motion strongly suggests an impending interaction such as “picking up the cup.” Similarly, anticipating gaze behavior benefits from contextual information about ongoing or upcoming interactions; for example, if a person is about to open a door, their gaze is likely to shift toward the doorknob before the action occurs. By integrating these two tasks into a unified model, shared representations that capture both spatial-temporal patterns of interaction and attention dynamics can be leveraged. Such an approach enables richer contextual understanding of human behavior as a whole. Moreover, an end-to-end trainable model eliminates the need for task-specific pipelines or post-processing steps, reducing computational overhead while ensuring seamless coordination between recognition and anticipation of HOI and gaze.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like reference numerals designate corresponding parts throughout the different views.

FIG. 1 is a schematic diagram of a system for predicting future actions from a video, according to an embodiment.

FIG. 2 shows an embodiment of the flow of operations.

FIG. 3 shows details of gaze detection module, action detection module, gaze anticipation module, and action anticipation module, as well as the interactions between each other and the GCSA submodule, according to an embodiment.

FIG. 4 shows details of a GCSA submodule, according to an embodiment.

FIG. 5 shows details of a GCTP submodule, according to an embodiment.

FIG. 6 shows a computer-implemented method of predicting future actions from a video, according to an embodiment.

Other systems, methods, features, and advantages of the disclosure will be, or will become, apparent to one of ordinary skill in the art upon examination of the following figures and detailed description. It is intended that all such additional systems, methods, features, and advantages be included within this description and this summary, be within the scope of the disclosure, and be protected by the following claims.

While various embodiments are described, the description is intended to be exemplary, rather than limiting, and it will be apparent to those of ordinary skill in the art that many more embodiments and implementations are possible that are within the scope of the embodiments. Although many possible combinations of features are shown in the accompanying figures and discussed in this detailed description, many other combinations of the disclosed features are possible. Any feature or element of any embodiment may be used in combination with or substituted for any other feature or element in any other embodiment unless specifically restricted.

This disclosure includes and contemplates combinations with features and elements known to the average artisan in the art. The embodiments, features, and elements that have been disclosed may also be combined with any conventional features or elements to form a distinct invention as defined by the claims. Any feature or element of any embodiment may also be combined with features or elements from other inventions to form another distinct invention as defined by the claims. Therefore, it will be understood that any of the features shown and/or discussed in the present disclosure may be implemented singularly or in any suitable combination. Accordingly, the embodiments are not to be restricted except in light of the attached claims and their equivalents. Also, various modifications and changes may be made within the scope of the attached claims.

### DETAILED DESCRIPTION

Human object interactions, gaze patterns, and their anticipation are intricately linked, providing valuable insights into cognitive processes, intentions, and behavior. The disclosed systems/methods include synchronized action and gaze estimation, which integrates simultaneous recognition and anticipation of both human object interaction and human gaze into a single unified end-to-end trainable model. This approach leverages a transformer-based architecture and incorporates gaze data into spatio-temporal attention mechanisms to simultaneously predict current and future human actions and gaze behavior. This bidirectional relationship between gaze and actions can be utilized under different scenarios, whether requiring a close-up, detailed view (first-person) or a wider, more contextual view (third-person), making the framework versatile for various applications. By offering a holistic understanding of human actions and attention, the disclosed embodiments pave the way for more natural and intuitive human-machine interactions and opens new avenues for applications in cognitive rehabilitation and behavior analysis.

Generally disclosed are embodiments of systems and methods of predicting future actions from a video. The disclosed systems and methods can use a video of human interactions with an object as input to predict future human actions. The disclosed systems and methods generally detect the gaze of the human in the video and the action (or human-object interactions (HOI)) of the human in the video to predict a future gaze. The detected gaze and action, as well as the predicted future gaze, can be used to predict future actions (or HOI) of the human in the video.

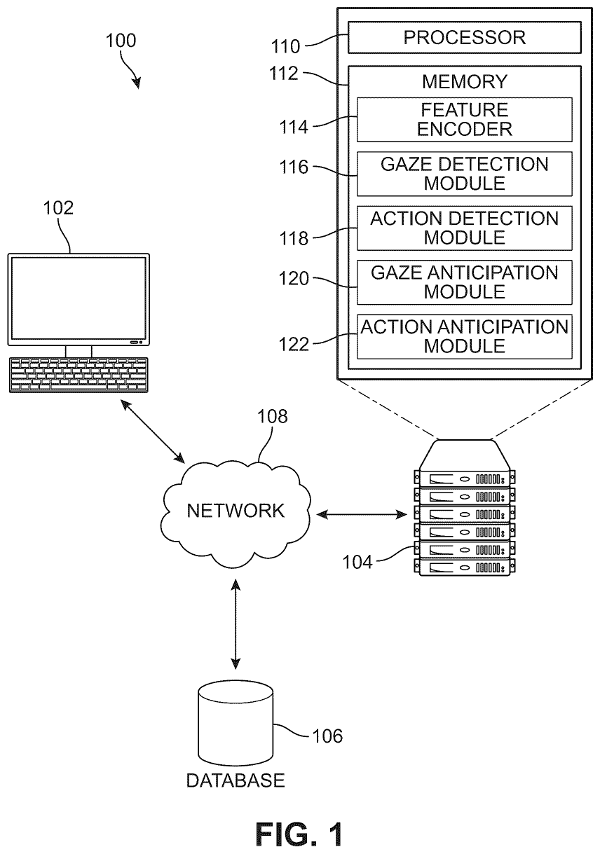

FIG. 1 is a schematic diagram of a system for predicting an action 100 (or system 100), according to an embodiment. During use, a user (via a user device) may interact with the system to predict an action. The disclosed system may include a plurality of components capable of performing the disclosed computer implemented method. For example, system 100 includes a user device 102, a computing system 104, and a database 106. Database 106 may store information, such as training data.

The components of system 100 can communicate with each other through a communication network 108. For example, user device 102 may retrieve a video from database 106 via communication network 108. In some embodiments, communication network 108 may be a wide area network (“WAN”), e.g., the Internet. In other embodiments, communication network 108 may be a local area network (“LAN”).

While FIG. 1 shows one user device, it is understood that one or more user devices may be used. For example, in some embodiments, the system may include two or three user devices. In some embodiments, the user devices may be computing devices used by a user. For example, user device 102 may include a smartphone or a tablet computer. In other examples, user device 102 may include a laptop computer, a desktop computer, and/or another type of computing device. The user devices may be used for inputting, processing, and displaying information. In some embodiments, a digital video camera may be used to generate images/videos used for analysis in the disclosed method. In some embodiments, the user device may include a digital camera that is separate from the computing device. In other embodiments, the user device may include a digital camera that is integral with the computing device, such as a camera on a smartphone or tablet.

As shown in FIG. 1, in some embodiments, a feature encoder 114, a gaze detection module 116, an action detection module 118, a gaze anticipation module 120, an action anticipation module 122, and a GCSA submodule 124 can be hosted in a computing system 104. The combination of modules makes up a computer model.

Computing system 104 includes a processor 110 and a memory 112. Processor 110 may include a single device processor located on a single device, or it may include multiple device processors located on one or more physical devices. Memory 112 may include any type of storage, which may be physically located on one physical device, or on multiple physical devices. In some cases, computing system 104 may comprise one or more servers that are used to host the system.

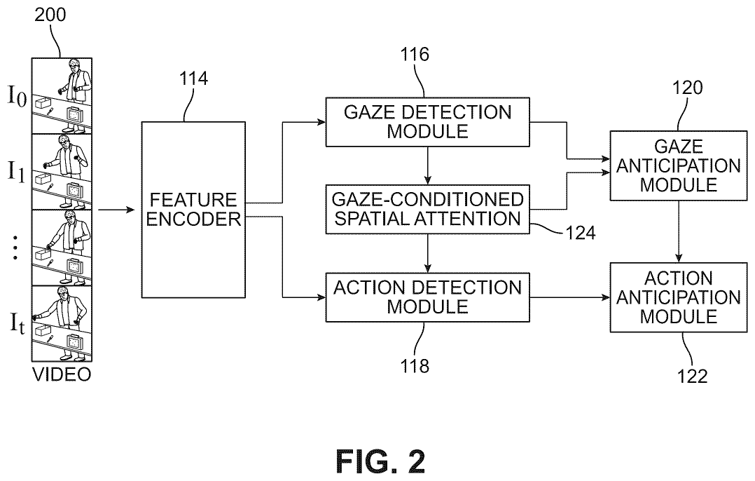

FIG. 2 shows an embodiment of the flow of operations. Generally, feature encoder 114 can embed input data (e.g., video clips/frames 200) as a feature encoding representing a human-object pair that is salient in the corresponding video clip/frame. In other words, feature encoder 114 can encode the input video clips/frames 200 as multiple possible human-object pairs, including the appearance and location features. Frames 200 of a video can be input into feature encoder 114 to convert each frame to a feature encoding representing a human-object pair that is salient in the corresponding video clip/frame. The feature encoding is input into both gaze detection module 116 and the action detection module 118 to analyze actions (or HOIs) and human gaze behavior.

Gaze detection module 116 can detect the gaze of the human in the video. The detected gaze and the feature encodings can be input into action detection module 118 to detect an action (or HOI) of the human in the video. Gaze anticipation module 120 can use the detected action (or HOI) of the human in the video to predict a future gaze. Action anticipation module 122 can use the detected gaze and action, as well as the predicted future gaze, to predict future actions (or HOIs) of the human in the video.

Action detection module 118 can use output of feature encoder 114 and output of gaze detection module 116 with GCSA bias applied to detect human actions (or HOIs) in the videos. Gaze anticipation module 120 can use output from gaze detection module to predict future gaze for M steps. Action anticipation module 122 can use output from gaze anticipation module 120 and action detection module 118 to predict future actions (or HOIs) for M steps.

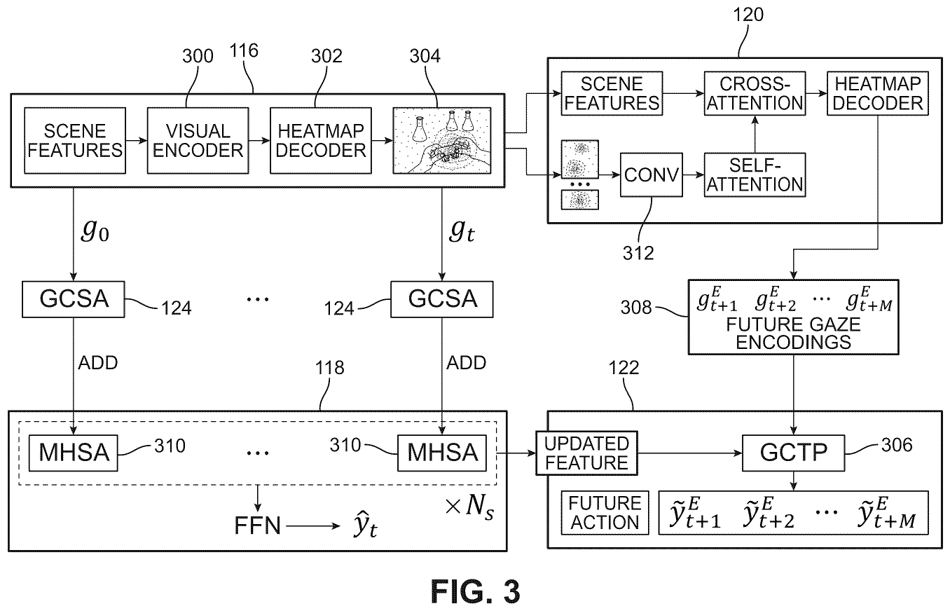

FIG. 3 shows details of gaze detection module 116, action detection module 118, gaze anticipation module 120, and action anticipation module 122, as well as the interactions between each other and the GCSA submodule, according to an embodiment. Gaze detection module 116 can include a gaze-following model that predicts the probability of a gaze fixation point in a scene (video clip/frame). The predicted gaze can be used to calculate a score factor for each possible gaze-object pair.

Gaze detection module 116 is p(g_{0:t}|I_{0:t}). Gaze detection module 116 can include a general visual encoder 300 and a heatmap decoder 302 for predicting gaze fixation heatmaps 304.

For egocentric videos, the input sequence can be split into non-overlapping patches of dimensions. Each patch can then be transformed using a linear mapping function to project the flattened patch into a D-dimensional vector space. The video tokens can be feed into transformer layers consisting of multiple self-attention blocks.

To produce the gaze fixation heatmaps, a transformer decoder can be adopted to upsample the encoded features, which consists of multiple multiscale self-attention blocks. Heatmap decoder 302 can produce feature maps. A SoftMax operation can be applied on the last dimension to predict a gaze fixation heatmap 304.

For third-person view videos, a gaze detection model can be initiated with pretrained weights.

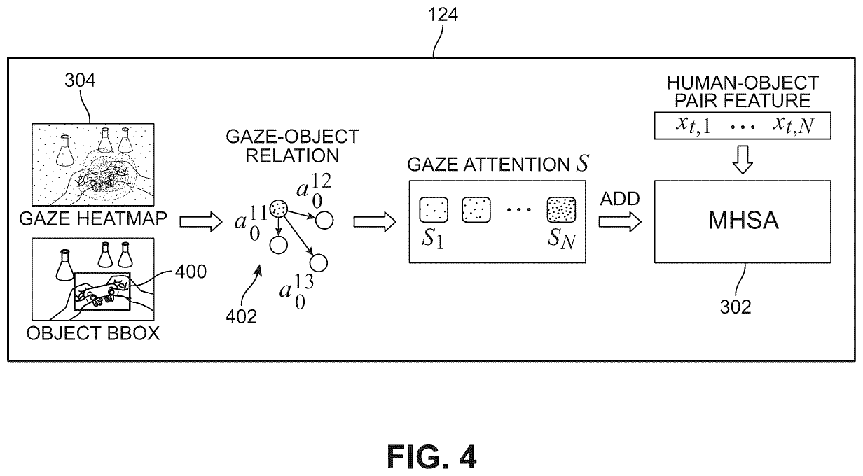

FIG. 4 shows details of a GCSA submodule 124, according to an embodiment. The gaze fixation heatmaps 304 produced by gaze detection module 116 and object bounding boxes 400 for video clips/frames corresponding to the gaze fixation heatmaps 304 can be used to create gaze-object relation maps 402. For example, given the object bounding box for an object j in an image, a gaze-conditioned score s_{t,j} can be generated.

For each human-object pair, sⱼ can be calculated and a gaze-conditioned score matrix Sₜ can be generated for every video clip/frame. The generated gaze-conditioned score matrix Sₜ can be applied as an attention bias, GCSA, in a Multi-Head Self-Attention (MHSA) layer of a transformer of action detection module 118. The gaze-object score S can be applied as an attention bias in action detection module 118 for predicting a classification probability vector for human actions.

FIG. 3 shows action detection module 118, according to an embodiment. Action detection module 118 can predict a current action conditioned on the gaze and video feature. Action detection module 118 can include a spatio-temporal transformer architecture designed for the action detection task. For example, action detection module 118 can include the spatio-temporal transformer architecture described in https://doi.org/10.48550/arXiv.2306.03597 (Zhifan Ni, Esteve Valls Mascaro, Hyemin Ahn, and Dongheui Lee. Human-object interaction prediction in videos through gaze following. Computer Vision and Image Understanding, 233:103741, 2023), incorporated herein by its entirety. The spatio-temporal transformer can be applied to aggregate contexts from a sliding window of frames. The spatio-temporal transformer can include a spatial encoder and a temporal encoder. The spatial encoder can exploit gaze-object appearance representations from each video frame to understand the dependencies between the visual appearances and spatial relations. The spatial encoder can receive the gaze-object pair relation representations Xₜ within one video frame as the input.

For egocentric videos,

$${n}_{t}^{s} = 1 and {n}_{t}^{0} = 0$$

is the number of detected object in frame t. One learnable global token cₜ pretended to the spatial encoder can be attached as input, representing the global representation of frame t. After Nₛₚ stacked self-attention layers, the global token summarizes the dependencies between gaze-object pairs to the global appearance feature vector, while the pair relation representations are refined to

$${X}_{t}^{sp} .$$

The temporal encoder can integrate high-level context features with refined pair representations through cross-attention layers, enabling it to capture the evolution of dependencies over time. This process is crucial for detecting human actions (or HOIs) in videos. The global embedding vector for each frame can be added to the Periodic Positional Encoding (PPE) before feeding them to the temporal transformer layer. The temporal layer can include a self-attention layer, a cross-attention layer, and a Feed Forward Network (FFN).

As shown in FIG. 3, GCSA bias can be added to each gaze output from gaze detection module 116 and the gaze output with the GCSA bias added can be input into a corresponding MHSA layer before being input into the FFN to output the predicted classification probability vector for human actions yₜ and updated human-object interaction features. The output of the FFN can be input into action anticipation module 122.

FIG. 3 shows gaze anticipation module 120, according to an embodiment. Gaze anticipation module 120 can predict future gaze(s) based on a sequence of observed images and gaze features. Gaze anticipation module 120 can include multiple (e.g., Nₜ) transformer layers. Gaze anticipation module 120 can include a self-attention layer, a cross-attention layer, and an FFN. Gaze anticipation module 120 can receive both an input video I_{0:t} and predicted gaze fixation heatmap g_{0:t} (from gaze detection module 116) as input and can use this input to predict a future M-step gaze position.

With the gaze fixation heatmap g_{0:t}, gaze anticipation module 120 can apply convolution layers 312 to generate gaze feature vectors. The gaze feature vectors can be added to PPE and then feed to temporal layer as ĝ_{0:t}. Then, cross-attention can be applied among the past gaze feature and the video feature for anticipating future gaze. Anticipated future gaze encodings 308, which can be represented as

$${g}_{t + 1}^{E} {g}_{t + 2}^{E} … {g}_{t + M}^{E} ,$$

can be passed to action anticipation module 122.

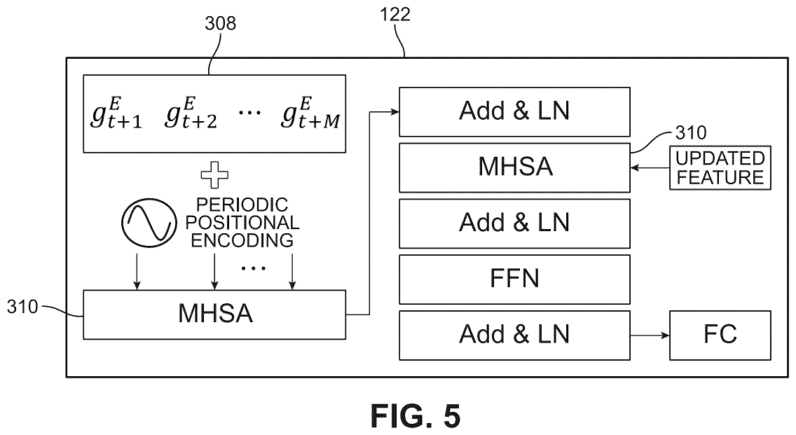

Action anticipation module 122 can receive the predicted future gaze, refined video features, and encoding of the last detected actions as input and can predict the next action(s) y_{t+M}. Action anticipation module 122 can predict future actions using updated encoded features from action detection module 118 and anticipated gazes from gaze anticipation module 120. Action anticipation module 122 can include a GCTP submodule 306. FIG. 5 shows details of a GCTP submodule 306, according to an embodiment. GCTP submodule 306 can include a self-attention layer that encodes a temporal correlation among the future gaze predicted by gaze anticipation module 120. Cross-attention can be applied among the updated video feature from action detection module 118 and the anticipated future gaze encodings 308 passed to action anticipation module 122 after self-attention. The temporal relations among future actions and future gaze can be implicitly learned through the processes performed by the layers of GCTP submodule 306, and these temporal relations can be used by action detection module 118 to predict future action(s) y_{t+M}.

A significant advantage of the disclosed embodiments is generalizability across different viewpoints. Disclosed embodiments are adept at detecting human actions in both first-person view (FPV) and third-person view (TPV), achieving this through minor modifications in the feature encoding and gaze detection modules. In this section, the discussion focuses on how the disclosed embodiments accommodate First-Person View (FPV) and Third-Person View (TPV) scenarios. During the feature encoding phase, the primary distinctions manifest in the generation of human-object pairs. For TPV videos, the encoding can comprehensively capture the active person's appearance and location as represented within Xₜ. The spatial relationship between humans and objects is crucial for recognizing actions in this viewpoint. Conversely, FPV videos typically do not provide visibility of the active person's location. In these cases, the model shifts to encode human hand positions instead of the full human body position within Xₜ. Additionally, adjustments in the gaze detection module are necessary when transitioning between FPV and TPV, involving switches between a TPV-specific gaze following model (such as the model described in Eunji Chong, Yongxin Wang, Nataniel Ruiz, and James M. Rehg. Detecting attended visual targets in video. In Proceedings of the IEEE/CVF conference on computer vision and pattern recognition, pages 5396-5406, 2020, incorporated by reference in its entirety) and an egocentric gaze model (such as the model described in Bolin Lai, Miao Liu, Fiona Ryan, and James M Rehg. In the eye of transformer: Global-local correlation for egocentric gaze estimation and beyond. International Journal of Computer Vision, pages 1-18, 2023, incorporated by reference in its entirety). Both models predict gaze fixation heatmaps scaled to the scene image, facilitating seamless integration with the action recognition modules.

Different loss functions for predicting actions and gaze can be used to train the disclosed joint model. One loss function is a visual attention heatmap loss defined as the L2 loss between the predicted heatmap g and the ground truth heatmap g^{gt}. Another loss function is the in-out loss function defined as the binary cross-entropy between the predicted in-out label oₚ and the ground truth o_{gt}, indicating whether the gaze target is within its frame. This loss can be applied when the in-out label is available. Yet another loss function is the action loss, which can include Cross-Entropy loss for detecting or anticipating human action.

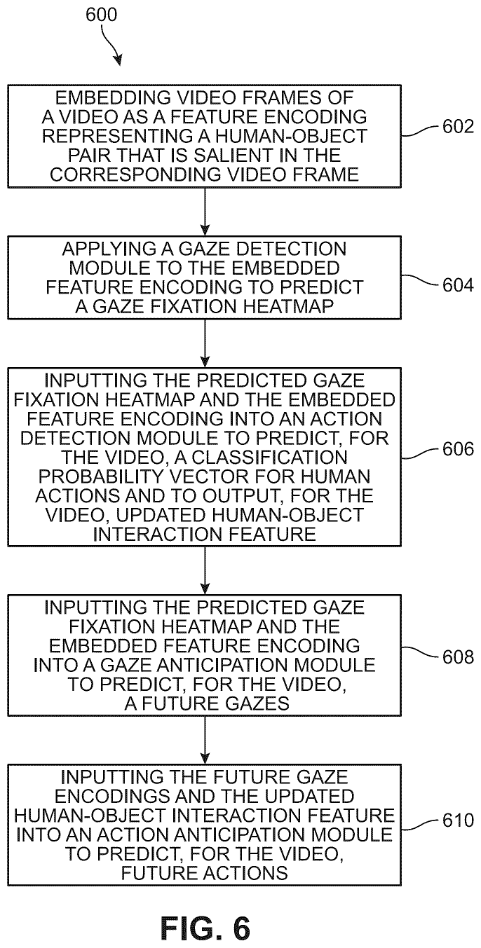

FIG. 6 shows a computer-implemented method of predicting future actions from a video 600 (or method 600), according to an embodiment. The computer-implemented method can include obtaining or receiving a video. For example, the video can include a human interacting with an object. The computer-implemented method can include embedding video frames of the video as a feature encoding representing a human-object pair that is salient in a corresponding video frame (operation 602). The computer-implemented method can include applying a gaze detection module to the embedded feature encoding to predict a gaze fixation heatmap (operation 604). The computer-implemented method can include inputting the predicted gaze fixation heatmap and the embedded feature encoding into an action detection module to predict, for the video, a classification probability vector for human actions and to output, for the video, updated human-object interaction features (operation 606). The computer-implemented method can include inputting the predicted gaze fixation heatmap and the embedded feature encoding into a gaze anticipation module to predict, for the video, future gazes and outputting future gaze encodings (operation 608). The computer-implemented method can include inputting the future gaze encodings and the predicted classification probability vector for human actions into an action anticipation module to predict, for the video, future actions (operation 610).

The computer-implemented method can include using the predicted gaze fixation heatmap and object bounding boxes for video frames corresponding to the heatmaps to generate a gaze-conditioned score matrix for each video frame.

The computer-implemented method can include applying the gaze-conditioned score matrix as an attention bias in a Multi-Head Self-Attention (MHSA) layer of a temporal transformer layer of the action detection module to predict, for the video, the classification probability vector for human actions.

Predicting, for the video, the future gazes, can include applying convolution layers to the predicted gaze fixation heatmap to generate a gaze feature vector.

Predicting, for the video, the future gazes, can include applying cross-attention among the gaze feature vector and the embedded feature encoding.

Predicting, for the video, the future gazes, can include applying cross-attention to the generated gaze feature vector and the embedded feature encoding.

Predicting, for the video, the future actions can include applying cross-attention to the to the updated human-object interaction features and the future gazes after applying cross-attention.

Predicting, for the video, the future actions can include encoding, by a self-attention layer, a temporal correlation among predicted future gazes.

Embodiments may include a non-transitory computer-readable medium (CRM) storing software comprising instructions executable by one or more computers which, upon such execution, cause the one or more computers to perform the disclosed methods. Non-transitory CRM may refer to a CRM that stores data for short periods or in the presence of power such as a memory device or Random Access Memory (RAM). For example, a non-transitory computer-readable medium may include storage components, such as, a hard disk (e.g., a magnetic disk, an optical disk, a magneto-optic disk, and/or a solid-state disk), a compact disc (CD), a digital versatile disc (DVD), a floppy disk, a cartridge, and/or a magnetic tape.

Embodiments may also include one or more computers and one or more storage devices storing instructions that are operable, when executed by the one or more computers, to cause the one or more computers to perform the disclosed methods.

Certain embodiments may use cloud computing environments. Cloud computing environments can include, for example, an environment that hosts the services for impact analysis and detection described herein. The cloud computing environment may provide computation, software, data access, storage, etc. services that do not require end-user knowledge of a physical location and configuration of system(s) and/or device(s) that hosts the impact analysis and detection services. For example, a cloud computing environment may include a group of computing resources (referred to collectively as “computing resources” and individually as “computing resource”).

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some examples be excised from the combination, and the claimed combination may be directed to a sub-combination or variation of a sub-combination.

While various embodiments of the disclosure have been described, the description is intended to be exemplary, rather than limiting and it will be apparent to those of ordinary skill in the art that many more embodiments and implementations are possible that are within the scope of the disclosure. Various modifications and changes may be made within the scope of this disclosure.

We claim:

1. A computer-implemented method of predicting future actions from a video, comprising:
embedding video frames of the video as a feature encoding representing a human-object pair that is salient in a corresponding video frame;
applying a gaze detection module to the embedded feature encoding to predict a gaze fixation heatmap;
inputting the predicted gaze fixation heatmap and the embedded feature encoding into an action detection module to predict, for the video, a classification probability vector for human actions and to output, for the video, updated human-object interaction features;
inputting the predicted gaze fixation heatmap and the embedded feature encoding into a gaze anticipation module to predict, for the video, future gazes and outputting future gaze encodings; and
inputting the future gaze encodings and the updated human-object interaction features into an action anticipation module to predict, for the video, future actions.

2. The computer-implemented method of claim 1, further including:
using the predicted gaze fixation heatmap and object bounding boxes for video frames corresponding to the heatmaps to generate a gaze-conditioned score matrix for each video frame; and
applying the gaze-conditioned score matrix as an attention bias in a Multi-Head Self-Attention (MHSA) layer of a temporal transformer layer of the action detection module to predict, for the video, the classification probability vector for human actions.

3. The computer-implemented method of claim 2, wherein predicting, for the video, the future gazes, includes applying convolution layers to the predicted gaze fixation heatmap to generate a gaze feature vector.

4. The computer-implemented method of claim 3, wherein predicting, for the video, the future gazes, includes applying cross-attention among the gaze feature vector and the embedded feature encoding.

5. The computer-implemented method of claim 4, wherein predicting, for the video, the future gazes, includes applying cross-attention to the generated gaze feature vector and the embedded feature encoding.

6. The computer-implemented method of claim 5, wherein predicting, for the video, the future actions include applying cross-attention to the updated human-object interaction features and the future gazes after applying cross-attention.

7. The computer-implemented method of claim 6, wherein predicting, for the video, the future actions includes encoding, by a self-attention layer, a temporal correlation among predicted future gazes.

8. A system for predicting future actions from a video, comprising:
one or more computers and one or more storage devices storing instructions that are executable by the one or more computers to:
embed video frames of the video as a feature encoding representing a human-object pair that is salient in a corresponding video frame;
apply a gaze detection module to the embedded feature encoding to predict a gaze fixation heatmap;
input the predicted gaze fixation heatmap and the embedded feature encoding into an action detection module to predict, for the video, a classification probability vector for human actions and to output, for the video, updated human-object interaction features;
input the predicted gaze fixation heatmap and the embedded feature encoding into a gaze anticipation module to predict, for the video, future gazes and output future gaze encodings; and
input the future gaze encodings and the updated human-object interaction features into an action anticipation module to predict, for the video, future actions.

9. The system of claim 8, wherein the instructions are further executable by the one or more computers to:
use the predicted gaze fixation heatmap and object bounding boxes for video frames corresponding to the heatmaps to generate a gaze-conditioned score matrix for each video frame; and
apply the gaze-conditioned score matrix as an attention bias in a Multi-Head Self-Attention (MHSA) layer of a temporal transformer layer of the action detection module to predict, for the video, the classification probability vector for human actions.

10. The system of claim 9, wherein predicting, for the video, the future gazes, includes applying convolution layers to the predicted gaze fixation heatmap to generate a gaze feature vector.

11. The system of claim 10, wherein predicting, for the video, the future gazes, includes applying cross-attention among the gaze feature vector and the embedded feature encoding.

12. The system of claim 11, wherein predicting, for the video, the future gazes, includes applying cross-attention to the generated gaze feature vector and the embedded feature encoding.

13. The system of claim 12, wherein predicting, for the video, the future actions includes applying cross-attention to the updated human-object interaction features and the future gazes after applying cross-attention.

14. The system of claim 13, wherein predicting, for the video, the future actions includes encoding, by a self-attention layer, a temporal correlation among predicted future gazes.

15. A non-transitory computer-readable medium storing software comprising instructions that are executable by one or more computers to predict future actions from a video by:
embedding video frames of the video as a feature encoding representing a human-object pair that is salient in a corresponding video frame;
applying a gaze detection module to the embedded feature encoding to predict a gaze fixation heatmap;
inputting the predicted gaze fixation heatmap and the embedded feature encoding into an action detection module to predict, for the video, a classification probability vector for human actions and to output, for the video, updated human-object interaction features;
inputting the predicted gaze fixation heatmap and the embedded feature encoding into a gaze anticipation module to predict, for the video, future gazes and outputting future gaze encodings; and
inputting the future gaze encodings and the updated human-object interaction features into an action anticipation module to predict, for the video, future actions.

16. The non-transitory computer-readable medium of 15, wherein the instructions are further executable by the one or more computers to:
use the predicted gaze fixation heatmap and object bounding boxes for video frames corresponding to the heatmaps to generate a gaze-conditioned score matrix for each video frame; and
apply the gaze-conditioned score matrix as an attention bias in a Multi-Head Self-Attention (MHSA) layer of a temporal transformer layer of an action detection module to predict, for the video, the classification probability vector for human actions.

17. The non-transitory computer-readable medium of claim 16, wherein predicting, for the video, the future gazes, includes applying convolution layers to the predicted gaze fixation heatmap to generate a gaze feature vector.

18. The non-transitory computer-readable medium of claim 17, wherein predicting, for the video, the future gazes, includes applying cross-attention among the gaze feature vector and the embedded feature encoding.

19. The non-transitory computer-readable medium of claim 18, wherein predicting, for the video, the future gazes, includes applying cross-attention to the generated gaze feature vector and the embedded feature encoding.

20. The non-transitory computer-readable medium of claim 19, wherein predicting, for the video, the future actions includes applying cross-attention to the updated human-object interaction features and the future gazes after applying cross-attention.
